(19) United States
(12) Patent Application Publication
(10) Pub. No.: US 2016/0023712 A1
(43) Pub. Date: Jan. 28, 2016

(54) BICYCLE LINKING APPARATUS

(71) Applicant: Emmanuel PETIT-FRERE, Palm Beach Gardens, FL (US)

(72) Inventor: Emmanuel PETIT-FRERE, Palm Beach Gardens, FL (US)

(21) Appl. No.: 14/341,462

(22) Filed: Jul. 25, 2014

(51) Int. Cl. B62K 27/12

(52) U.S. Cl. CPC B62K 27/12

(57) ABSTRACT

A bicycle linking apparatus may include a forward assembly and a rear assembly. The forward assembly may include a front bracket having a plurality of head stabilizer mounting holes and a plurality of swivel retractor mounting holes, two bicycle frame adapter brackets that may attach to the front bracket, a head stabilizer that may attach to the head stabilizer mounting holes of the front bracket, and a swivel retractor assembly that may attach to the swivel retractor mounting holes of the front bracket and may attach to the head stabilizer. The rear assembly may include a back/tail frame, a vertical latch bar that may attach to the back/tail frame, and two back/tail frame struts that may attach to the back/tail frame. The rear assembly of at least one leading bicycle may removably connect with the forward assembly of at least one trailing bicycle.

### BACKGROUND OF THE INVENTION

The present invention relates to bicycles and, more particularly, to a bicycle linking apparatus.

Currently, racing bicycles are usually used in individual cycling competitions. Tandem bike racing or riding is boring because individuals are stuck on a bike with no way to detach. The tandem bikes have fixed distances between each bicycle. The connection mechanisms connect to the seat post.

As can be seen, there is a need for a bicycle linking apparatus that allows for the connection and disconnect of bicycles when desired with a variable distance component.

### SUMMARY OF THE INVENTION

In one aspect of the present invention, a bicycle linking apparatus comprises: a forward assembly comprising; a front bracket having a plurality of head stabilizer mounting holes and a plurality of swivel retractor mounting holes; two bicycle frame adapter brackets attached to the front bracket; a head stabilizer attached to the head stabilizer mounting holes of the front bracket; and a swivel retractor assembly attached to the swivel retractor mounting holes of the front bracket and attached to the head stabilizer; and a rear assembly comprising; a back/tail frame; a vertical latch bar attached to the back/tail frame; and two back/tail frame struts attached to the back/tail frame, wherein the rear assembly removably connects with the forward assembly.

In another aspect of the present invention, a method for linking at least two bicycles comprises: attaching a forward assembly to a front of at least one trailing bicycle, wherein the forward assembly comprises a front bracket having a plurality of head stabilizer mounting holes and a plurality of swivel retractor mounting holes; two bike frame adapter brackets attached to the front bracket; a head stabilizer attached to the front bracket; and a swivel retractor assembly attached to the front bracket and attached to the head stabilizer; attaching a rear assembly to a rear of at least one leading bicycle, wherein the rear assembly comprises a back/tail frame; a vertical latch bar attached to the back/tail frame; and two back/tail frame struts attached to the back/tail frame; and removably connecting the rear assembly to the forward assembly.

These and other features, aspects and advantages of the present invention will become better understood with reference to the following drawings, description and claims.

### BRIEF DESCRIPTION OF THE DRAWINGS

FIG. 1 is a side view of an exemplary embodiment of the present invention shown in use;

FIG. 2 is a perspective view of an exemplary embodiment of the present invention shown in use;

FIG. 3 is a rear detail view of an exemplary embodiment of the present invention shown in use;

FIG. 4 is a perspective view of a forward assembly of an exemplary embodiment of the present invention;

FIG. 5 is an exploded view of the forward assembly of an exemplary embodiment of the present invention;

FIG. 6 is a front top perspective view of a back/tail frame of an exemplary embodiment of the present invention;

FIG. 7 is a front bottom perspective view of the back/tail frame of an exemplary embodiment of the present invention;

FIG. 8 is a front perspective detail view of a swivel retractor assembly shown in a retracted state;

FIG. 9 is a front perspective detail view of the swivel retractor assembly shown in an extended state;

FIG. 10 is a front perspective detail view of the swivel retractor assembly shown in exemplary rotated state; and

FIG. 11 is a rear perspective detail view of the swivel retractor assembly.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a bicycle linking apparatus that may include a forward assembly and a rear assembly. The forward assembly may include a front bracket having a plurality of head stabilizer mounting holes and a plurality of swivel retractor mounting holes, two bicycle frame adapter brackets that may attach to the front bracket, a head stabilizer that may attach to the head stabilizer mounting holes of the front bracket, and a swivel retractor assembly that may attach to the swivel retractor mounting holes of the front bracket and may attach to the head stabilizer. The rear assembly may include a back/tail frame, a vertical latch bar that may attach to the back/tail frame, and two back/tail frame struts that may attach to the back/tail frame. The rear assembly of at least one leading bicycle may removably connect with the forward assembly of at least one trailing bicycle.

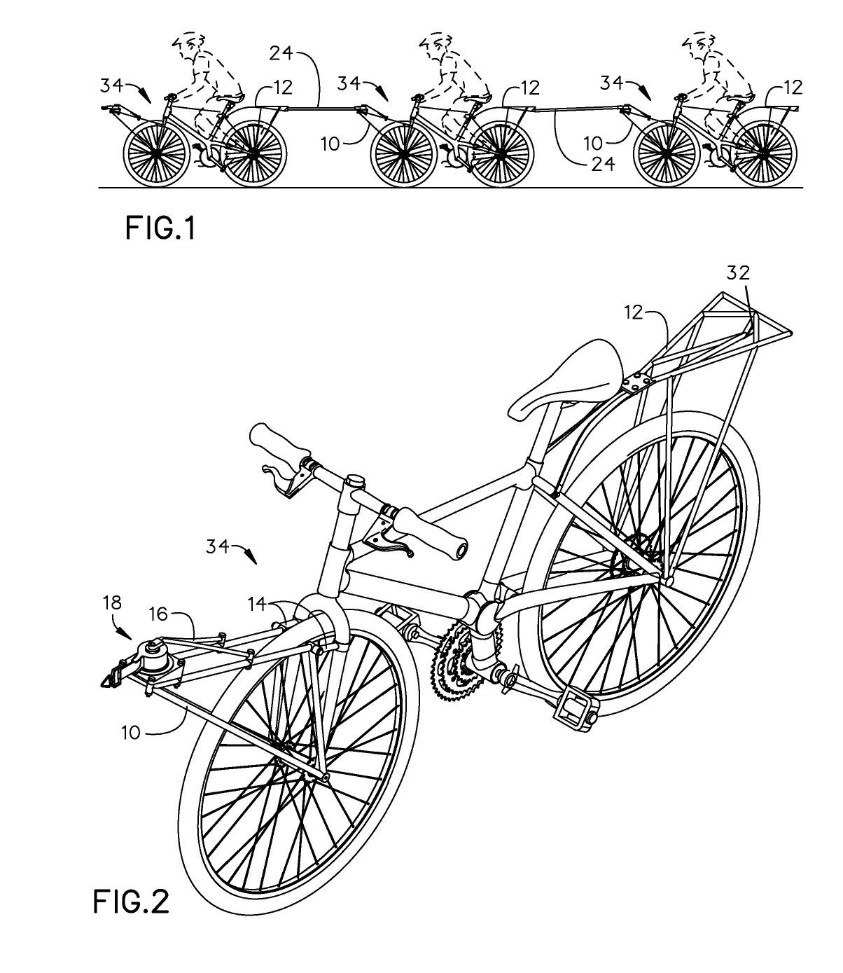

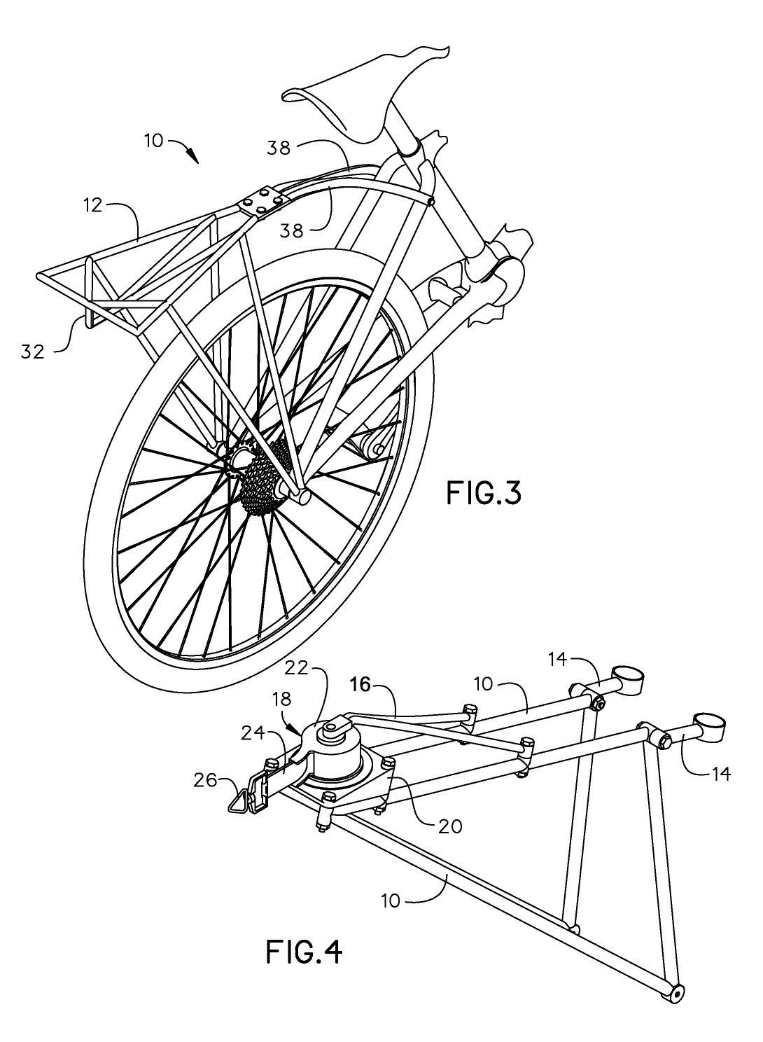

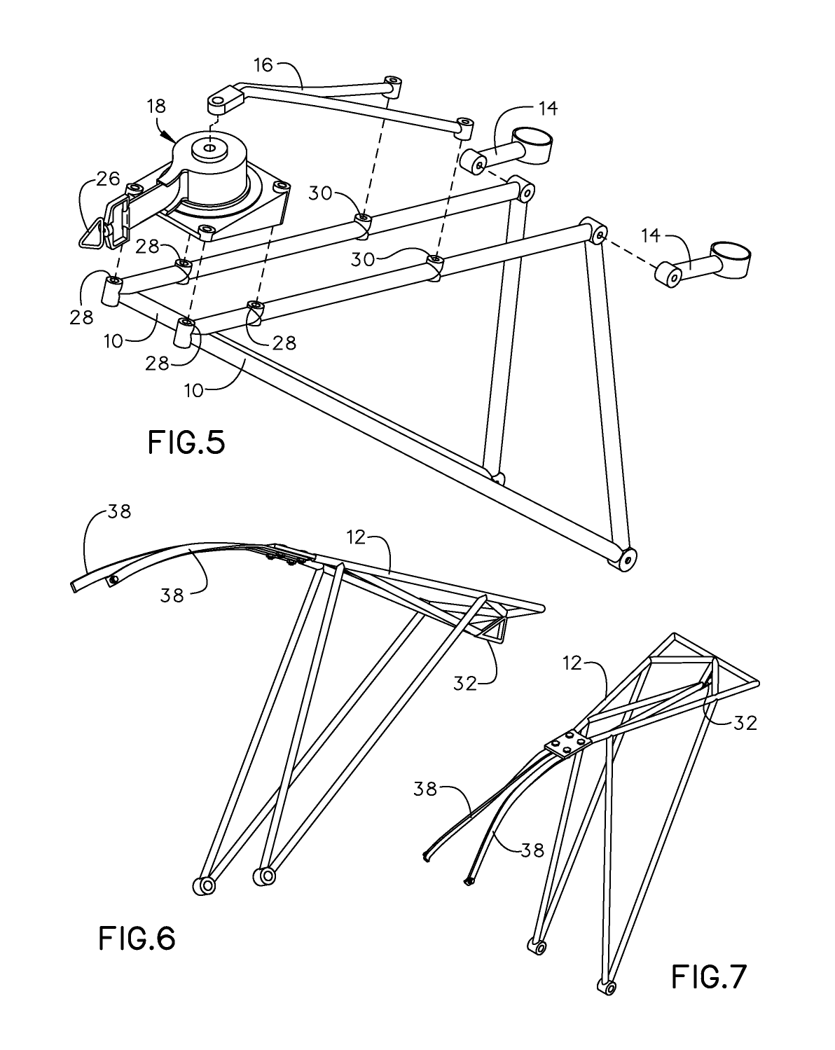

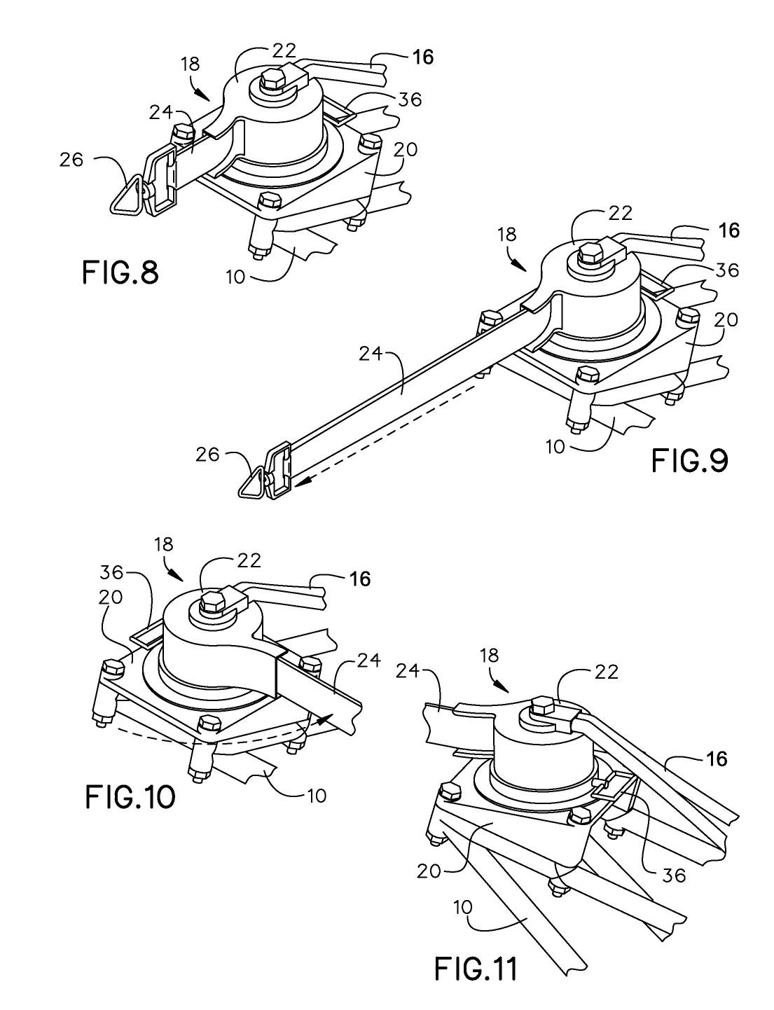

As is illustrated in FIGS. 1 through 11, a bicycle linking apparatus may include a forward assembly and a rear assembly. The forward assembly may include a front bracket 10 having a plurality of head stabilizer mounting holes 30 and a plurality of swivel retractor mounting holes 28. Two bicycle frame adapter brackets 14 may attach to the front bracket 10. A head stabilizer 16 may attach to the head stabilizer mounting holes 30 of the front bracket 10. A swivel retractor assembly 18 may attach to the swivel retractor mounting holes 28 of the front bracket 10. The swivel retractor assembly 18 may also attach to the head stabilizer 16. The rear assembly may include a back/tail frame 12, a vertical latch bar 32 attached to the back/tail frame 12, and two back/tail frame struts 38 attached to the back/tail frame 12.

In certain embodiments, the swivel retractor assembly 18 may include a base plate 20, a retractor housing 22 attached to the base plate 20, and a strap 24 having a first end and a second end. The first end of the strap 24 may connect to the interior of the retractor housing 22. The second end of the strap 24 may connect to an attachment mechanism such as a swivel carabineer 26 or the like. The head stabilizer 16 may attach to the retractor housing 22 of the swivel retractor assembly 18. In certain embodiments, a swivel lock 36 may attach to the retractor housing 22. The strap 24 may be retractable. In certain embodiments, the strap 24 may be self retractable. In certain embodiments, the strap 24 may be approximately seven feet in length.

In certain embodiments, the back/tail frame 12 may include two V-shaped sections attached to a substantially flat member. The two back/tail frame struts 38 may attach to the substantially flat member. The vertical latch bar 32 may attach to a bottom side of the substantially flat member.

In certain embodiments, the front bracket 10 may include two substantially triangle shaped members. The swivel retractor assembly 18 may be positioned on top of and connecting the substantially triangle shaped members.

A method of using the bicycle linking apparatus may include the following. A user may connect the forward assembly to a front of at least one trailing bicycle 34. The rear assembly may be attached to a rear of at least one leading bicycle 34. The rear assembly may be removably connected to the forward assembly. In certain embodiments, the attachment mechanism may removably attach to the vertical latch bar 32.

At least two bicycles 34 may be removably connected through at least one bicycle linking apparatus. When connected, the trailing bicycle 34 may be directly behind the leading bicycle, to the side, or the like. When moving over a surface, the attachment mechanism may operate to account for different angles, such as when turning or going up or down in elevation.

In certain embodiments, the forward assembly may removably attach to a front hub and a front fork of the bicycle 34. The front bracket 10 may removably attach to the front hub of the bicycle 34, and the bicycle frame adapter brackets 14 may removably attach to the front fork of the bicycle 34. In certain embodiments, the rear assembly may be removably attached to a rear hub and a seat stay of the bicycle 34. In certain embodiments, the two substantially V-shaped sections may removably attach to the rear hub, and the back/tail frame struts 38 may removably attach to the seat stay.

It should be understood, of course, that the foregoing relates to exemplary embodiments of the invention and that modifications may be made without departing from the spirit and scope of the invention as set forth in the following claims.

What is claimed is:

1. A bicycle linking apparatus comprising:
a forward assembly comprising;
a front bracket having a plurality of head stabilizer mounting holes and a plurality of swivel retractor mounting holes;
two bicycle frame adapter brackets attached to the front bracket;
a head stabilizer attached to the head stabilizer mounting holes of the front bracket; and
a swivel retractor assembly attached to the swivel retractor mounting holes of the front bracket and attached to the head stabilizer; and
a rear assembly comprising;
a back/tail frame;
a vertical latch bar attached to the back/tail frame; and
two back/tail frame struts attached to the back/tail frame, wherein the rear assembly removably connects with the forward assembly.

2. The bicycle linking apparatus of claim 1, wherein the swivel retractor assembly comprises a base plate, a retractor housing attached to the base plate, a swivel lock attached to the retractor housing, a strap having a first end connected to the interior of the retractor housing, and a second end attached to an attachment mechanism.

3. The bicycle linking apparatus of claim 1, wherein the back/tail frame comprises two substantially V-shaped sections attached to a substantially flat member, wherein the two back/tail frame struts attach to the substantially flat member.

4. The bicycle linking apparatus of claim 1, wherein the front bracket comprises two substantially triangle shaped members, wherein the swivel retractor assembly is positioned on top of and connecting the substantially triangle shaped members.

5. The method for linking at least two bicycles comprising:
attaching a forward assembly to a front of at least one trailing bicycle, wherein the forward assembly comprises a front bracket having a plurality of head stabilizer mounting holes and a plurality of swivel retractor mounting holes; two bike frame adapter brackets attached to the front bracket; a head stabilizer attached to the front bracket; and a swivel retractor assembly attached to the front bracket and attached to the head stabilizer;
attaching a rear assembly to a rear of at least one leading bicycle, wherein the rear assembly comprises a back/tail frame; a vertical latch bar attached to the back/tail frame; and two back/tail frame struts attached to the back/tail frame; and
removably connecting the rear assembly to the forward assembly.

6. The method of claim 5, wherein the forward assembly removably attaches to a front hub and a front fork of the trailing bicycle.

7. The method of claim 5, wherein the rear assembly removably attaches to a rear hub and a seat stay of the leading bicycle.

8. The method of claim 5, wherein the swivel retractor assembly comprises a base plate, a retractor housing attached to the base plate, a swivel lock attached to the retractor housing, a strap having a first end connected to the interior of the retractor housing, and a second end attached to an attachment mechanism.

9. The method of claim 8, wherein the strap of the forward assembly attaches to the vertical latch bar of the rear assembly.
